(19) United States
(12) Patent Application Publication
(10) Pub. No.: US 2018/0313142 A1
(43) Pub. Date: Nov. 1, 2018

(54) Balcony Shading and Power System

(71) Applicant: Shadecraft, Inc., Pasadena, CA (US)

(72) Inventor: Armen Sevada Gharabegian, Glendale, CA (US)

(73) Assignee: Shadecraft, Inc.

(21) Appl. No.: 15/854,636

(22) Filed: Dec. 26, 2017

Related U.S. Application Data
(60) Provisional application No. 62/492,949, filed on May 1, 2017.

(51) Int. Cl. E06B 9/24; H02J 3/38; H02J 7/35; H02J 7/32; H02S 20/30; F03D 13/20

(52) U.S. Cl. CPC E06B 9/24; H02J 3/383; H02J 3/386; H02J 7/35; H02J 7/32; E06B 2009/2476; F03D 13/20; E06B 2009/2458; F05B 2240/9112; F05B 2220/708; H02S 20/30

(57) ABSTRACT

A balcony shading and power system including one or more track assemblies, one or more movable panel assemblies positioned within at least one of the one or more track assemblies, and one or more driving assemblies to move the one or more panel assemblies. The one or more movable panel assemblies include one or more solar cells to convert light energy to electrical power and one or more wind power assemblies to capture wind and to generate electrical power from the captured wind. The one or more solar cells are attached to an outside surface of at least one of movable panel assemblies. The one or more wind power assemblies are integrated into at least one of the one or more movable panel assemblies.

### RELATED APPLICATIONS

This application claims priority to provisional patent application Ser. No. 62/492,949, filed May 1, 2017, entitled “Balcony Shading and Power System,” the disclosure of which is incorporated by reference.

### BACKGROUND

Many multi-story houses, hotels, apartments, condominiums and/or office buildings have balconies to allow users and/or visitors to enjoy the sun and enjoy views from different vantage points. These vantage points may provide beautiful views. Most office buildings, houses, apartments and/or condominiums that utilize solar panel have stationary solar panel assemblies mounted on a roof of a structure. The solar panel assemblies are not retractable and are positioned on a top surface of a building. Accordingly, only a top surface of a building, house, hotels, apartments or condominiums may be utilized to capture solar energy and convert solar energy into electrical power. Therefore, there is a need for more flexible solar power system.

### BRIEF DESCRIPTION OF DRAWINGS

FIG. 1 illustrates a block diagram of a balcony shading and power system according to embodiments;

FIG. 2A illustrates a front view of a movable and/or portable panel according to embodiments;

FIG. 2B illustrates a movable and/or portable panel having one or more solar cells or arrays and/or one or more wind power systems according to embodiments;

FIG. 2C illustrates a movable and/or portable panel having solar cells or solar arrays and wind power systems lying on its side according to embodiments;

FIG. 2D illustrates a movable and/or portable panel mounted on a base assembly according to embodiments;

FIG. 2E discloses a block diagram of a wind power system according to embodiments;

FIG. 2F illustrates a block diagram of a solar power system in one or more movable panels according to embodiments;

FIG. 2G illustrate a movable or portable panel having a cylindrical configuration according to embodiments;

FIG. 3A illustrates one or more movable or portable panels in a curved configuration according to embodiments;

FIG. 3B illustrates a diagram of a driving or panel movement assembly attached to one or more movable and/or portable panels;

FIG. 3C illustrates a block diagram of a driving system or movement assembly in a balcony shading and power system according to embodiments;

FIG. 3D illustrates portions of one or more panel driving and movement assemblies;

FIG. 4A illustrates a balcony having a shading and power system with one track according to embodiments;

FIG. 4B illustrates a balcony having a power and shading system having more than one tracks according to embodiments;

FIG. 4C illustrates a balcony having a balcony shading and power system having one curved track or channel (although more than one curved track or channel may be utilized in a balcony shading and power system) according to embodiments;

FIG. 5A illustrates positioning of a light source, a balcony, tracks and channels of a shading and power system and a user according to embodiments;

FIG. 5B illustrates a configuration of a sun, a balcony, a balcony shading and power system, and/or two visitors and guests according to embodiments;

FIG. 5C illustrates another configuration of a sun, a balcony, a balcony and power system and a number of visitors or guests according to embodiments; and

FIG. 6 illustrates a view of a balcony shading and power system from a point of view of an inside of a room according to embodiments.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more network devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example. A network may comprise two or more network and/or computing devices and/or may couple network and/or computing devices so that signal communications, such as in the form of signal packets, for example, may be exchanged, such as between a server and a client device and/or other types of devices, including between wireless devices coupled via a wireless network, for example. In this context, the term network device refers to any device capable of communicating via and/or as part of a network and may comprise a computing device. It should be understood that for ease of description a network device may be embodied and/or described in terms of a computing device and/or mobile computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

Computing devices, mobile computing devices, and/or network devices capable of operating as a server, or otherwise, may include, as examples, desktop computers, laptop computers, set top boxes, tablets, netbooks, smart phones, wearable devices, integrated devices combining two or more features of the foregoing devices, the like or any combination thereof. Signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases, database servers, application data servers, proxy servers, cloud-based storage servers, and/or portions thereof, as appropriate.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. For example, a signal transmitted from a motor controller or processor to a motor (or other driving assembly) may pass through glue logic, an amplifier, an analog-to-digital converter, a digital-to-analog converter, another controller and/or processor, and/or an interface. Similarly, a signal communicated through a misting system may pass through an air conditioning and/or a heating module, and a signal communicated from any one or a number of sensors to a controller and/or processor may pass through a conditioning module, an analog-to-digital controller, and/or a comparison module, and/or a number of other electrical assemblies and/or components.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include for example, past, present and/or future mass storage, such as cloud storage, cloud server farms, database servers, application servers, and/or other forms of computing and/or device readable media, for example. A network may include a portion of the Internet, one or more local area networks (LANs), one or more wide area networks (WANs), wire-line type connections, one or more personal area networks (PANs), wireless type connections, one or more mesh networks, one or more cellular communication networks, other connections, or any combination thereof. Thus, a network may be worldwide in scope and/or extent.

The Internet and/or a global communications network may refer to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet may include local area networks (LANs), personal area networks (PANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP) and/or other communication protocols. For example, network devices and/or computing devices may engage in an HTTP session through an exchange of appropriately compatible and/or compliant signal packets and/or frames. Here, the term Hypertext Transfer Protocol, HTTP, and/or similar terms is intended to refer to any version, now known and/or later developed. It is likewise noted that in various places in this document substitution of the term Internet with the term World Wide Web (‘Web’) may be made without a significant departure in meaning and may, therefore, not be inappropriate in that the statement would remain correct with such a substitution.

In embodiments, an Internet and/or the Web may comprise a worldwide system of interoperable networks, including interoperable devices within those networks. A content delivery server and/or the Internet and/or the Web, therefore, in this context, may comprise an service that organizes stored content, such as, for example, text, images, video, etc., through the use of hypermedia, for example. A HyperText Markup Language (“HTML”), Cascading Style Sheets (“CSS”) or Extensible Markup Language (“XML”), for example, may be utilized to specify content and/or to specify a format for hypermedia type content, such as in the form of a file and/or an “electronic document,” such as a Web page, for example.

Also as used herein, one or more parameters may be descriptive of a collection of signal samples, such as one or more electronic documents, and exist in the form of physical signals and/or physical states, such as memory states. For example, one or more parameters may include parameters, such as 1) how much an assembly (e.g., motor assembly) may move or be requested to move; 2) a time of day at which an image was captured, a latitude and longitude of an image capture device, such as a camera; 3) time and day of when a sensor reading (e.g., humidity, temperature, air quality, UV radiation) may be received and/or measurements or values of sensor readings; and/or 4) operating conditions of one or more motors or other components or assemblies in a balcony shading and power system. Claimed subject matter is intended to embrace meaningful, descriptive parameters in any format, so long as the one or more parameters comprise physical signals and/or states.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In embodiments, a modular umbrella shading system may comprise a computing device installed within or as part of a modular umbrella system, intelligent umbrella and/or intelligent shading charging system. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, such as a special purpose computer or a similar special purpose electronic computing device (e.g., such as a balcony shading and power system processor, controller and/or computing device). In the context of this specification, therefore, a special purpose computer or a similar special purpose electronic computing device (e.g., a balcony shading and power system processor, controller and/or computing device) is capable of manipulating or transforming signals (electronic and/or magnetic) in memories (or components thereof), other storage devices, transmission devices sound reproduction devices, and/or display devices.

In an embodiment, a controller and/or a processor typically performs a series of instructions resulting in data manipulation. In an embodiment, a microcontroller or microprocessor may be a compact microcomputer designed to govern the operation of embedded systems in electronic devices, e.g., a balcony shading and power system processor, controller and/or computing device or single board computers, and various other electronic and mechanical devices coupled thereto or installed thereon. Microcontrollers may include processors, microprocessors, and other electronic components. Controller may be a commercially available processor such as an Intel Pentium, Raspberry Pi, other Linux-based computers, Motorola PowerPC, SGI MIPS, Sun UltraSPARC, or Hewlett-Packard PA-RISC processor, but may be any type of application-specific and/or specifically designed processor or controller. In an embodiment, a processor and/or controller may be connected to other system elements, including one or more memory devices, by a bus, a mesh network or other mesh components. In embodiments, a processor and/or controller may be connected to other devices also via power buses from either a rechargeable power source and/or a solar charging assembly. Usually, a processor or controller, may execute an operating system which may be, for example, a Windows-based operating system (Microsoft), a MAC OS System X operating system (Apple Computer), one of many Linux-based operating system distributions, a portable electronic device operating system (e.g., mobile phone operating systems), microcomputer operating systems, and/or a UNIX operating systems. Embodiments are not limited to any particular implementation and/or operating system.

The specification may refer to a balcony shading and power systems as an apparatus that provides shade and/or coverage to a user from weather elements such as sun, wind, rain, and/or hail on a structure balcony. In embodiments, the balcony shading and power system may be an automated, intelligent and/or employ artificial intelligence and/or machine learning. The balcony shading and power system may also be referred to as a parasol, intelligent umbrella, sun shade, outdoor shade furniture, sun screen, sun shelter, awning, sun cover, sun marquee, brolly and other similar names, which may all be utilized interchangeably in this application

Structures with balconies (e.g., houses, hotels, apartments, condominiums and/or office buildings) may comprise a balcony shading and power system to provide shade to users and/or visitors. In embodiments, the balcony shading and power system may generate electrical power from solar energy (via solar panels) as well as wind energy (via wind propellers and/or wind turbines). In embodiments, one or more balconies on a building structure may have a balcony shading and power system. In other words, in embodiments, if a hotel has 50 balconies on each side of a hotel, the hotel may have one or up to 100 balcony shading and power systems.

In embodiments, a balcony shading system may be in a retracted position when the balcony shading and power system is stored on one side of a balcony. In embodiments, a resident or visitor may desire to see a view from a balcony and/or to sunbathe. In these situations, a balcony shading and power system may not be requested and/or needed. In embodiments, due to positioning of a light source (e.g., sun and/or other obstructions), a resident, guest and/or visitor may desire to deploy a balcony shading and power system in order to provide shade from, for example, the light source (e.g., the sun). In embodiments, a shading and power system may comprise one or more movable panels, a panel driving assembly, and one or more track assemblies to provide a path on which one or movable panels and/or panel driving assembly is to move. A part of one surface of one or more movable or portable panels may comprise solar cells and/or solar panel assemblies to convert solar energy into electrical energy. In embodiments, an outside surface of one or more movable or portable panels may comprise solar cells and/or solar panel assemblies. In embodiments, a portion of a surface (e.g., outside surface) of one or more movable or portable panels may comprise a vent, a screen and/or a channel to direct wind to one or more fan assemblies, which may be connected to one or more shafts, which may be connected to one or more wind turbines to convert captured wind or wind into electrical energy. In embodiments, one or more shading panels may be adjustable or rotatable to adjust to a light source moving (e.g., movement of a sun). Thus, in addition, to one or more shading panels being movable to adjust an angle of shading as a sun moves throughout the day, one or more shading panels may be utilized to generate electrical energy from solar panels or cells, wind turbines, and/or both. This may significantly reduce power consumption of structures in environments where sun is prevalent and/or wind is also present. This is a significant advantage over prior art structures where solar panels are only located on roofs of structures. A significant increase in solar power generation and/or wind power generation may be possible as compared to a solar panel on roof only systems. In addition, during daytime, solar panels and/or assemblies may generate electrical energy and during nighttime, wind turbines may generate power, so as long as there is wind, a balcony shading and power system may be generating power for a structure (e.g., such as a hotel, office building, parking structure) during a large portion of a day and night. In embodiments, a building structure may generate enough electricity to power a number of the assemblies and devices in a structure and thus may need a minimum amount of energy from a power grid.

In embodiments, one or more panel driving assemblies may be located on top of or above one or more movable or portable panels. In embodiments, one or more panel driving assemblies may be located in a housing or outside structure that is located above the one or more movable or portable panels. In embodiments, one or more panel driving assemblies may be located on a bottom or below one or more movable or portable panels. In embodiments, one or more panel driving assemblies may be located in a housing or an outside structure that is located below the one or more portable panels (on a balcony). In embodiments, one or more panel driving assemblies may comprise one or more motor controllers, one or more motors and/or actuators, one or more shafts and/or one or more gears or gearing assemblies. In embodiments, the driving assemblies may cause movement of one or more movable or portable panels from a storage, closed and/or retracted position to an open, deployed and/or expanded position to provide shade. In embodiments, the driving assemblies may move the panels to different positions along a track where panels are partially deployed and/or are fully deployed. In embodiments, if a movable panel is partially deployed and/or fully deployed, the one or more solar panels or solar arrays, and/or the one or more wind turbines may be utilized to generate power. In embodiments, each movable and/or portable panels may have a driving assembly (e.g., its own movable or portable panel) and the driving assemblies for each of the movable and/or portable panels may comprise interconnected driving assemblies (through additional gearing assemblies and/or connection assemblies). In embodiments, one driving assembly may move more than one movable or portable panel. In embodiments, one or more driving assemblies may each correspond and/or be located within a track assembly, underneath a track assembly or underneath a track assembly. In embodiments, one or more track assemblies may provide a path and/or channels for one or more movable or portable panels to travel from a storage, closed and/or retracted position to a partially open position and/or to a fully open, deployed and/or expanded position and vice versa. In embodiments, one or more track assemblies may provide a straight path. In embodiments, one or more track assemblies may provide a curved path or a zig-zag path, although many other paths are possible. In embodiments, one or more track assemblies may be located above or on top of one or more movable or portable panels. In embodiments, one or more track assemblies may be located below or on bottom of one or movable or portable panels. In embodiments, one or more track assemblies may be located above and below one or more movable or portable panels to provide additional support for the movable or portable panels.

In embodiments, one or more driving assemblies may be controlled either by a manual switch (located on a movable or portable panel and/or a track assembly). In embodiments, a manual switch may be attached to a motor controller and may provide simple open or expand, (or retract/close), commands, instructions or signals to a motor controller. In embodiments, a balcony shading and power system may further comprise one or more processors and/or controllers, one or more memory devices and computer-readable instructions stored in the one or more memory devices. In embodiments, a balcony shading and power system may comprise one or more transceivers to receive communications from external computing devices (e.g., portable computing devices and/or remote computing devices). In embodiments, a balcony shading and power system may comprise a control panel and/or a remote control to communicate commands, instructions and/or signals to a motor controller and the motor controller may communicate commands and/or signals to a driving assembly to expand and/or open, (or retract and/or close), one or more movable or portable panels. In embodiments, a portable computing device (e.g., laptop, table, wearable computing device), a mobile communication device (e.g., smart phone, mobile phone), and/or a remote computing device may communicate instructions, messages and/or commands to one or more processors and/or controllers in an intelligent shading and power system. In embodiments, computer-readable instructions may be executed by a processor and/or controller in an intelligent shading and power system and communicate instructions, commands and/or messages to a motor controller and a motor controller may communicate commands and/or signals to a remainder of a driving assembly to expand and/or open (or retract and/or close) one or more movable or portable panels. This provides an advantage over prior art shading systems in that an intelligent shading and power system may be controlled by one or more devices, remote controls and/or switches.

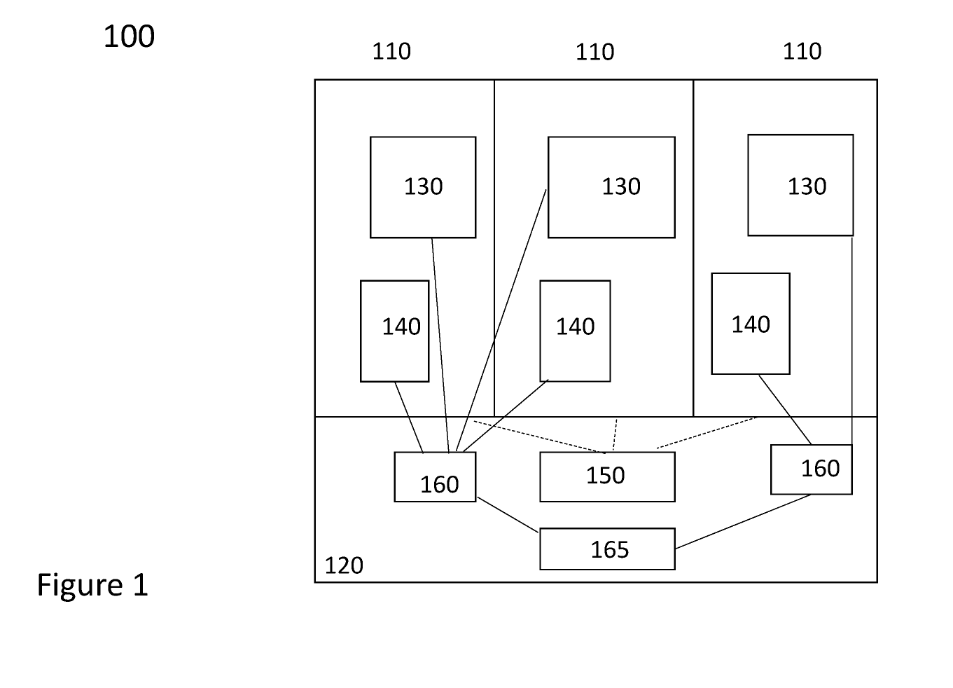

FIG. 1 illustrates a block diagram of a balcony shading and power system according to embodiments. In embodiments, a balcony shading and power system 100 may comprise one or more movable or portable panels 110, one or more guidance assemblies or systems (e.g., one or more track assemblies or systems) 120, one or more solar power systems 130, one or more wind power systems 140, and one or more panel movement systems 150 (e.g., one or more driving assemblies). In embodiments, a balcony shading and power system 100 further comprises one or more renewable power sources 160 (e.g., a rechargeable battery) and/or one or more power supplies 165. In embodiments, one or more movable or portable panels 110 may be positioned and/or reside in one or more track assemblies 120 in order to provide a guidance and support (or track or guide) when the one or more movable panels 110 open or expand (or retract or close). In embodiments, one or more movable and/or portable panels 110 may comprise one or more solar power systems 130 (e.g., one or more solar panel assemblies, an inverter, a converter and/or a solar power charging assembly) to generate power from a light source (e.g., the sun) and/or may comprise one or more wind power systems 140 (e.g., one or more blades/propellers, one or more shafts, one or more gearing assemblies, and one or more generators or turbine) to generate power from the wind, respectively. In embodiments, one or more solar power systems 130 and/or one or more wind power systems 140 may generate electrical power (e.g., voltage and/or current) and transfer the electrical power to a renewable power source (e.g., a rechargeable battery 160) and/or to a power supply 165. In embodiments, a power supply 165 and/or a rechargeable battery 160 may provide power to one or more panel movement systems 150 (e.g., drive assemblies). In embodiments, one or more panel movement systems 150 (e.g., driving assemblies) may move one or more movable or portable panels 110 to a partially open and/or expanded position and/or a fully open and/or expanded position, and conversely to a retracted and/or closed position.

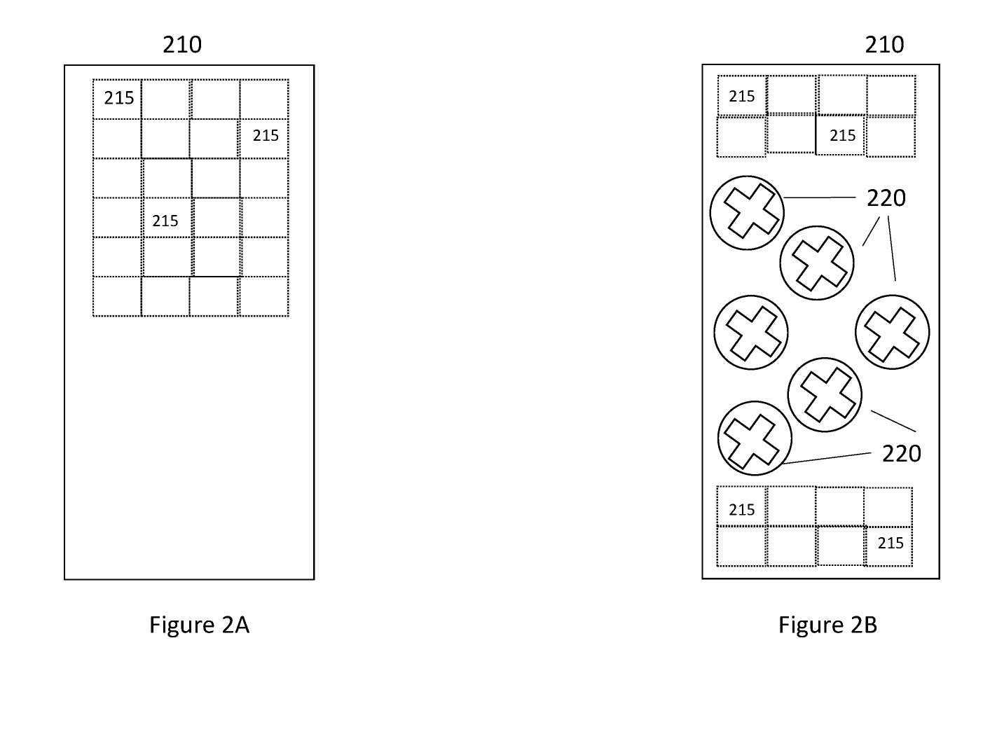

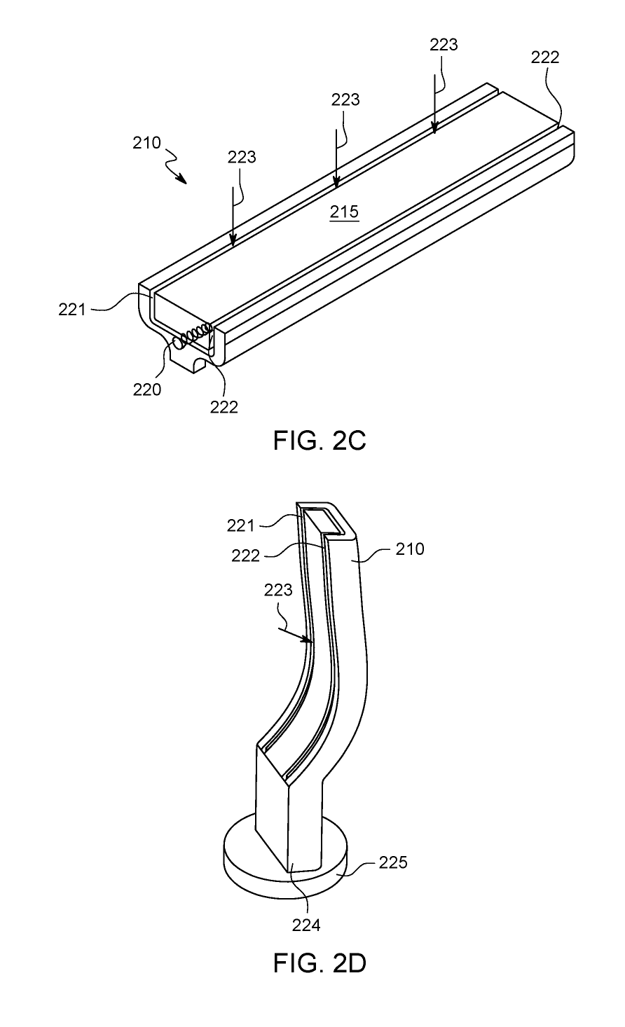

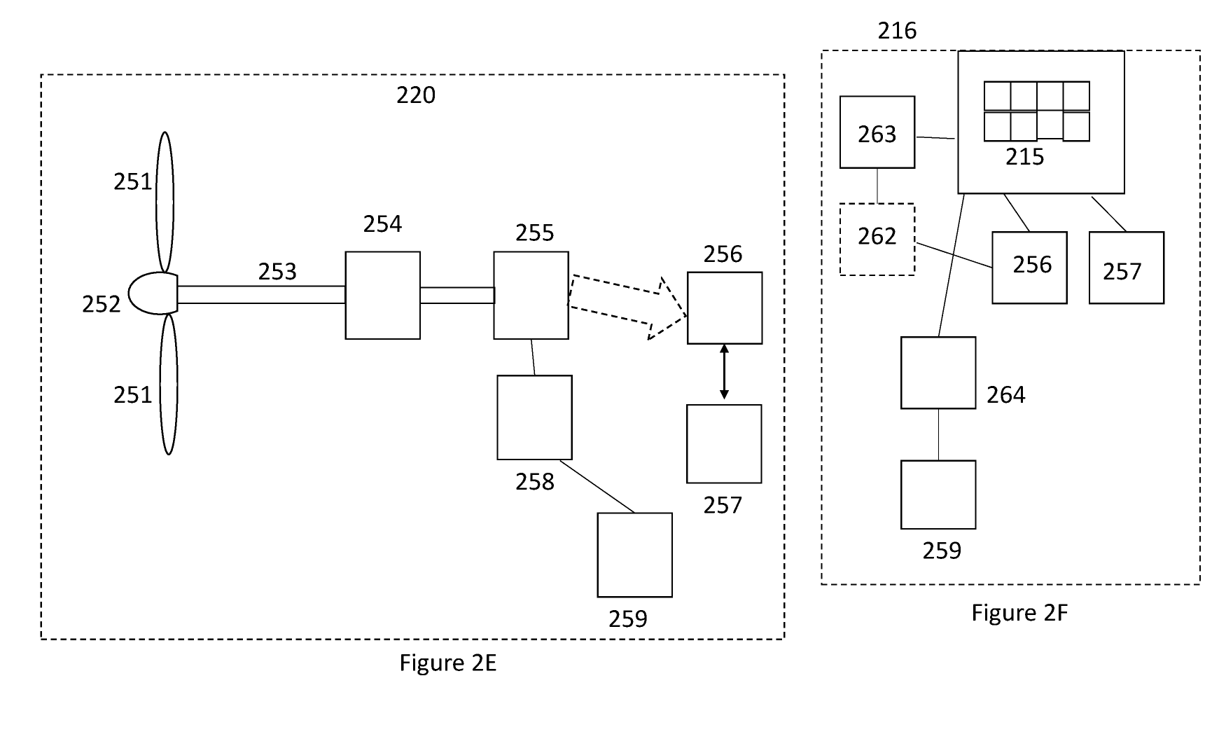

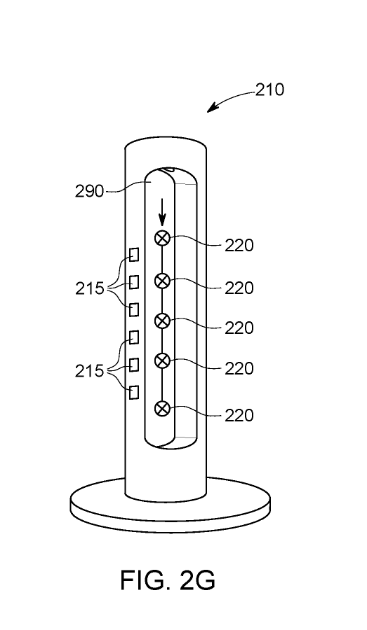

In embodiments, one or more movable and/or portable panels 110 may have a rectangular design with one or more flat surfaces. FIG. 2A illustrates a front view of a movable and/or portable panel according to embodiments. In embodiments, one or more movable or portable panels 210 may have one or more solar panels or arrays 215 installed thereon. In embodiments, one or more solar cells, panels or arrays 215 may be installed or positioned on an outside surface of a movable and/or portable panel 110. In embodiments, one or more solar cells, panels or arrays 215 may be integrated into one or more movable or portable panels 210. In embodiments, one or more solar cells, panels or arrays 215 be installed on one or two surfaces of a movable and/or portable panel 210.

FIG. 2B illustrates a movable and/or portable panel having one or more solar cells or arrays and/or one or more wind power systems according to embodiments. FIG. 2B illustrates a movable and/or portable panel 210 comprising one or more solar cells or arrays 215 and one or more wind power assemblies 220 according to embodiments. In embodiments, one or more solar cells or arrays are positioned on a top and/or bottom section or portion of one or more movable or portable panels 210 and one or more wind power assemblies 220 may be positioned and/or located in a middle section or portion of a movable and/or portable panel 210. In embodiments, one or more wind power assemblies 220 may be located behind a mesh and/or screen which keeps large objects from entering one or more wind power assemblies 220. Depending on power capacity of solar cells or arrays 215, a smaller or larger number of solar cells or arrays may be installed and/or positioned on one or more movable and/or portable panels than what is illustrated in FIG. 2B. In embodiments, a number of solar cells or solar arrays may depend on how much power may be utilized per room in a building structure. In addition, depending on estimated and/or prior measured wind direction, a smaller or larger number of wind power systems and/or assemblies 220 may be installed on or within one or more movable and/or portable panels 210. In addition, depending on actual, predicted or estimated wind direction and/or speed, one or more wind power systems and/or assemblies 220 may be installed at different locations on one or more movable and/or portable panels 210 (e.g., bottom, top, left side and/or right side) depending on where wind is expected and/or estimated from being received from (e.g., a direction of wind and/or when a wind direction is expected to change).

FIG. 2C illustrates a movable and/or portable panel having solar cells or arrays and wind power systems according to embodiments. In embodiments, a movable and/or portable panel 210 may comprise one or more solar cells or arrays 215. In embodiments, one or more movable and/or portable panels 210 may comprise one or more wind channels (e.g., left wind channel 221 and right wind channel 222) to capture wind movement coming in a direction such as illustrated by reference numeral 223. In embodiments, wind may be directed through a channel to cause portions or parts of a wind power system 220 to move and/or rotate and generate electrical power. In embodiments, one or more movable and/or portable panels may have wind channels located at different locations (e.g., in a center of a movable or portable panel or on a top and/or bottom of a movable or portable panel). In embodiments, wind channels may comprise a plurality of holes (or circular, rectangular, square or oval openings) to capture wind and to funnel it or move it to one or more wind power assemblies 220. FIG. 2D illustrates a movable and/or portable panel mounted on a base assembly according to embodiments. In embodiments, a movable and/or portable panel 210 may comprise one or more wind channels 221 221 and one or more solar panels and/or cells 215. In FIG. 2D, wind may be directed at a movable and/or portable panel from a direction, as illustrated by reference number 223. In embodiments, a movable and/or portable panel 210 may be connected to a mounting assembly 224 and a mounting assembly 224 may be connected to a base assembly including a driving assembly and/or rotating assembly 225. In embodiments, one or more movable or portable panels 210 may have removable and/or detachable solar cells and/or arrays. In such embodiments, wind power assemblies 220 (e.g., fans, shafts, gears and/or turbines) may be located underneath removable and/or detachable solar cells and/or arrays and may be exposed and/or utilized after solar cells and/or solar arrays are detached and/removed. In embodiments, one or more wind power systems 220 may have reflective coatings and/or one or more solar cells and/or arrays may be located on a surface of components of wind power systems. Thus, when wind power systems are not being utilized, portions and/or components of wind power assemblies may be utilized as solar cells to generate electrical energy. In embodiments, one or more wind power systems 220 may be positioned on sides of movable and/or portable panels 210 so as to have more of a surface of a movable and/or portable panels 210 to have more solar cells and/or arrays integrated within and/or located on a surface.

FIG. 2E discloses a block diagram of a wind power system according to embodiments. In embodiments, a wind power system 220 comprises one or more propellers or blades 251, one or more caps 252, one or more shafts and/or turning assemblies 253, one or more gearing assemblies 254 and/one or more generators 255. In embodiments, a wind power system 220 may comprise one or more renewable power sources 256 (e.g., rechargeable batteries) and/or power supplies or power sources 257. In embodiments, a wind power system 220 may comprise an inverter 258 to convert DC power to AC power. In embodiments, wind may cause one or more propellers or blades 251 to turn and/or rotate. In embodiments, a cap 252 along with a rotation of the one or more blades and/or propellers 251 causes rotation of one or more shafts 253. In embodiments, a rotation speed of the one or more shafts 253 may be proportional to captured wind speed. In embodiments, one or more shafts 253 may be mechanically coupled to a one or more gearing assemblies 254. In embodiments, one or more gearing assemblies 254 may be connected and/or coupled to the one or more generators (or one or more wind turbines) 255. In embodiments, rotation of the one or more shafts 253 may cause rotation of one or more gears in a gearing assembly 254 (e.g., a gearbox) which causes one or more generators 255 to generate electrical power (e.g., voltage and current). An amount of power generated may depend on length of shafts and/or gearing assemblies as well as speed of rotation of one or more blades or propellers 251. In embodiments, one or more generators (or wind turbines) 255 may generate AC and/or DC power. In embodiments, involving wind power systems 220, one or more generators 255 may generate DC power. In embodiments, one or more generators 255 may transfer power (e.g., current and/or voltage) to one or more renewable power sources (e.g., rechargeable batteries) 256 which may store energy for operation of a balcony shading and power system 200. In embodiments, one or more renewable power sources 256 may transfer and/or provide power to one or more power supplies 257 which in turn may provide power to components and/or assemblies of a balcony shading and power system 200. In embodiments, a wind power system 220 may generate extra power (e.g., more power than need by balcony shading and power system 200) and may be able to transfer power to a power system in a structure (e.g., building, hotel, condo, apartment) to reduce a structure's reliance on grid power (and thus reduce building expenses). In embodiments, a generator 255 may supply AC power to a structure power system 259. In embodiments, a generator 255 may transfer AC power to an inverter 258 which may match an AC power amplitude and/or frequency generated by a generator to amplitude and/or frequency utilized by a structure power system 259.

FIG. 2F illustrates a block diagram of a solar power system in one or more movable panels according to embodiments. In embodiments, a solar power system 216 may comprise one or more solar cells or arrays 215, one or more rechargeable sources 256 (e.g., batteries), one or more power supplies 257, and one or more DC to AC inverters and/or converters 261. In embodiments, a solar power system 216 may comprise a diode 262 to protect a battery and/or solar cells or arrays 215. In embodiments, a solar power system 216 may comprise a solar charge controller 263. In embodiments, a solar charge controller 263 may the power going into one or more rechargeable sources 256 from a solar array or cells. In embodiments, a solar charge controller or solar controller 263 may ensure that one or more rechargeable power sources (e.g., batteries) are not overcharged during daytime, and that generated power doesn't run or transfer backwards to the solar panels or solar cells or arrays 215 overnight and drain power from one or more rechargeable power sources 256. In embodiments, solar cells and/or arrays 215 may generate DC electrical power and thus may transfer power to one or more rechargeable power sources 256 (batteries) to charge batteries. In embodiments, solar cells and/or arrays 215 may transfer and/or communicate power (e.g., voltage and/or current) to one or more power sources 257 (e.g., power supplies). In embodiments, one or more power supplies 257 may provide voltage and/or current to components in a balcony shading and power system 200. In embodiments, a solar power system 216 may generate more power than is needed or utilized by a balcony shading power system 200 and may transfer power to a structure power system 259. Because a solar power system 216 generally generates DC power, an inverter or DC to AC converter 264 may receive generated power (e.g., excess generated power) from a solar power system 216 and convert received power to AC power which is utilized by a structure power system 259. In embodiments, a DC to AC converter 264 may transfer AC power to a structure power system 259.

FIG. 2G illustrate a movable or portable panel having a cylindrical configuration according to embodiments. In embodiments, a movable or portable panel 210 may comprise a panel body 289, one or more channels or openings 290, one or more solar cells and/or arrays 215 and one or more wind power assemblies 220 (e.g., fans, shafts, gears and/or turbines). In embodiments, one or more wind power assemblies 220 may capture wind passing through a channel or opening 290 in a center of a movable and/or portable panel 210. In embodiments, such as illustrated in FIG. 2G, one or more solar cells 215 may be placed on and/or positioned on one or more surfaces of a panel body 289. In embodiments, a cylindrically configured panel body 210 may also rotate to follow the sun and/or follow the wind. In embodiments, a balcony wind and power system such as pictured in FIG. 2G, may comprise a solar power system 210 as described in FIG. 2E and a wind power system 220 as described in FIG. 2F.

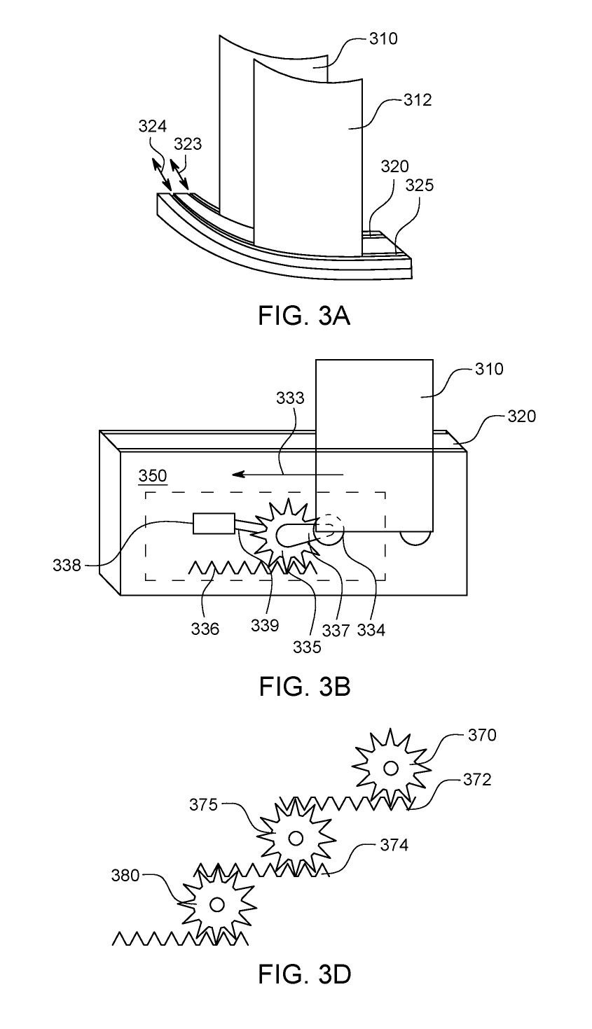

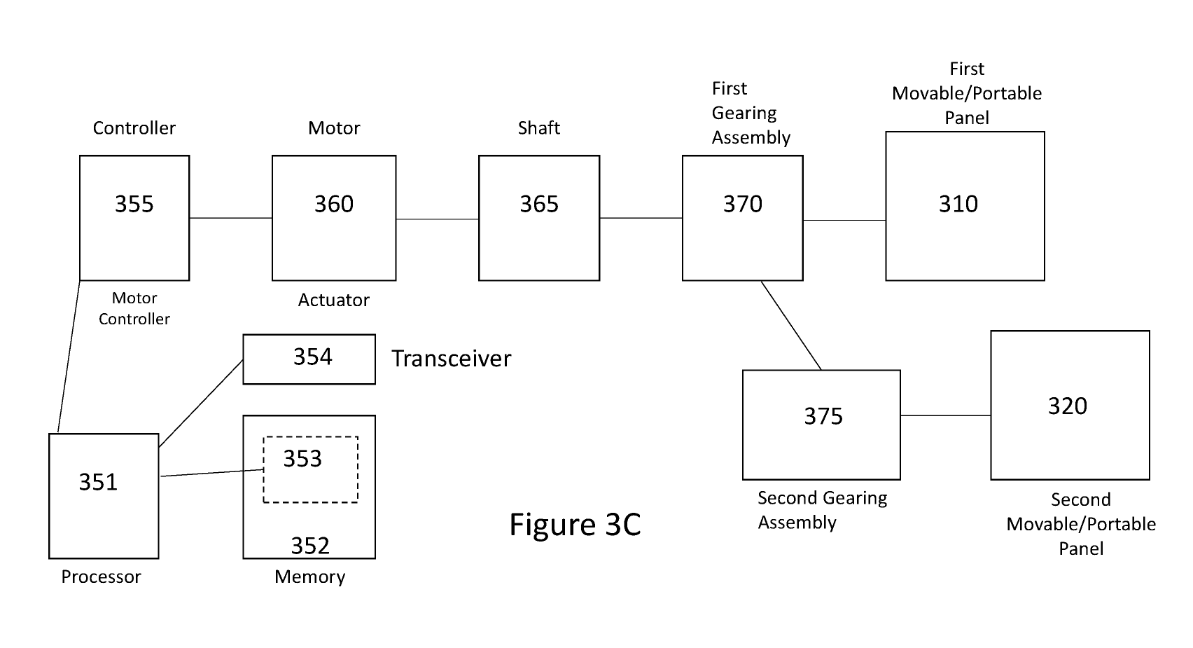

FIG. 3A illustrates one or more movable or portable panels in a curved configuration according to embodiments. In embodiments, a track assembly and/or guidance assembly may be curved as illustrated in FIG. 3A. In embodiments, for example, a track assembly and/or guidance assembly may comprise one or more tracks and/or channels. In embodiments, for example, FIG. 3A, a track assembly and/or guidance assembly comprise a first track or channel 320 and/or a second track or channel 325. In embodiments, a first movable or portable panel 310 may travel and/or move in a left and/or right direction within the first track or channel 320. This travel and/or movement is illustrated by reference number 323 in FIG. 3A. In embodiments, a second movable or portable panel 312 may travel and/or move in a left and/or right direction within a second track or channel 325. This travel and/or movement is illustrated by reference number 324 in FIG. 3A. In embodiments, a first movable or portable panel 310 and/or a second movable or portable panel 320 may be connected, attached and/or mechanically coupled to one or more driving assemblies or panel movement assemblies 350. In embodiments, a first movable or portable panel 310 and/or a second movable or portable panel 320 may be connected at a bottom portion of a panel to one or more driving or panel movement assemblies 350. This may be referred to, for example, a first movable or portable panel 320 sitting or positioned within a first track or channel 320 and connected or coupled to one or more driving or panel movement assemblies 350. In embodiments, a top portion of a first movable or portable panel 310 and/or a top portion of second movable or portable panel 312 may be connected to one or more driving or panel movement assemblies 350. In embodiments, for example, a first movable or portable panel 310 may be hanging and/or positioned within a first track or channel 320 and connected to one or more driving or panel movement assemblies 350.

FIG. 3B illustrates a diagram of a driving or panel movement assembly attached to one or more movable and/or portable panels. As discussed above, one or more panel driving and/or movement assemblies 350 may drive and/or move a first movable or portable panel 310 and/or a second movable or portable panel 312 within a track or channel (e.g., track or channels 320 or 325). FIG. 3C illustrates a block diagram of a driving system or movement assembly in a balcony shading and power system according to embodiments. As illustrated in FIG. 3C, a panel driving or movement assembly 350 may comprise one or more motor controllers 355, one or more motors, one or more cables and ropes, and/or one or more linear actuators 360, one or more shafts 365, one or more first gearing assemblies 370 and/or one or more second gearing assemblies 375. In embodiments, one or more motor controllers 355 may receive movement commands, instructions and/or messages via voice control, a control panel, a manual switch, portable computing devices (e.g., smartphone, laptops, tablets, etc.), computing devices and/or remote computing devices. In embodiments, one or more motor controllers 355 may communicate received information, messages and/or commands with one or more motors 360 to rotate. In embodiments, rotation of one or more motors 360 may cause rotation of one or more shafts and/or rods 365, which in turn may cause rotation of one or more gearing assemblies 370. In embodiments, one or more gearing assemblies 370 may cause movement or travel on one or more first movable and/or portable panel 310. In embodiments, one or more gearing assemblies 370 may comprise a gear couple to a shaft (e.g., via a ball bearing), where the gear is attached to a first movable and/or portable panel 310 and rotation of a shaft and/or gear may cause first panel 310 travel and/or movement within a track or channel 320. In embodiments, one or more gearing assemblies 370 may comprise one or more gears which are interconnected. In such embodiments, interconnected gears may rotate in response to rotation of one or more shafts and may cause movement of a first panel in different directions and/or different speeds. In embodiments, one or more of the interconnected gears may be connected, attached and/or coupled to a first panel 310 via a fastener, screw, adhesive, and/or plate. In embodiments, one or more first gearing assemblies 370 or one or second gearing assemblies 375 may comprise gears which have teach which engage a gear tread or gear track, where a gear track or tread is moving and/or alternatively, where a gear track or tread is stationary and gears may be moving. In embodiments, one or more driving and/or movement assemblies 350 may comprise a cable and/or motor system, a rack gear and/or motor system and/or an actuator system.

FIG. 3D illustrates portions of one or more panel driving and movement assemblies. In embodiments, such as illustrated in FIG. 3D, a connector or fastener 334 may be attached, connected and/or coupled to a first movable or portable panel 310 either directly and/or indirectly via one or more plates or connection elements 337. In embodiments, one or more connection elements 337 or 334 may be coupled, connected and/or attached to one or more gears 335. In embodiments, one or more gears 335 may be coupled, connected or attached to one or more gear treads or tracks 336. In embodiments, one or more shafts 339 are coupled, connected and/or attached to one or more motors 338 on one end and one or more gears 335 on a second end. In embodiments, a motor 338 and/or one or more shafts 339 may be connected, coupled and/or attached to one or more gear treads or tracks 336 to cause movement of gear treads or tracks. In embodiments, rotation of a motor 338 (e.g., upon receipt of commands, instructions, signals or messages from a motor controller) may cause rotation of one or more shafts 339, which in turn cause rotation and/or movement of one or more gears 335 and/or one or more gear treads or tracks 336. In embodiments, movement and/or rotation of one or more gears 335 with respect to gear treads or tracks 336 may cause movement or travel of one or more plates or connection elements 337 and/or connectors or fasteners 334, which may in turn cause movement of one or more first panels 310 in a direction (e.g., a left direction or a right direction). In embodiments, movement of one or more first panels 310 is illustrated by reference number 333. In embodiments, interconnected gear assembly is illustrated in FIG. 3B, where a first gearing assembly 370 may be connected, coupled or attached to second gearing assembly 375 via an engagement assembly 372 (e.g., a gear track or tread assembly). In FIG. 3D, a second gearing assembly 375 may be coupled, connected or attached to a third gearing assembly 380 via an engagement assembly 374. In embodiments, such as illustrated in FIG. 3B, interconnected gearing assemblies may allow for coordinated, synchronous, and/or staggered movement of one or more movable and/or portable panels 310 and 320.

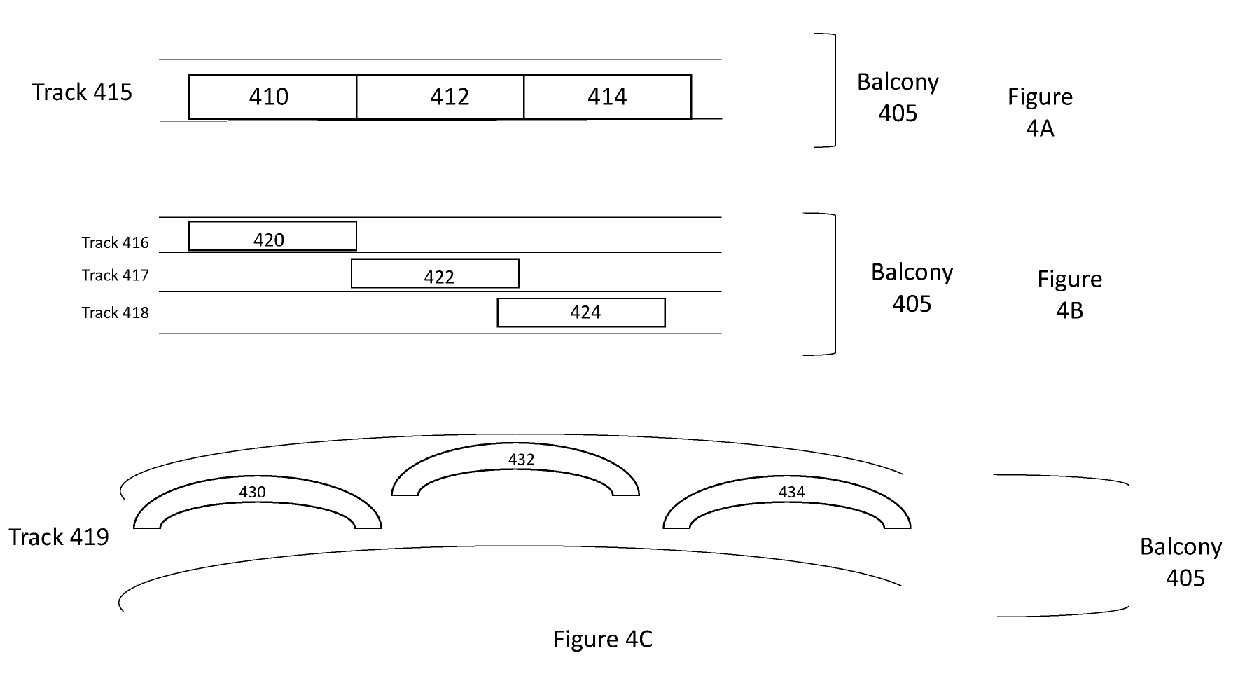

FIGS. 4A, 4B and 4C illustrates balconies with one or more movable and/or portable panels. FIG. 4A illustrates a balcony having a shading and power system with one track according to embodiments. In embodiments, FIG. 4A illustrates a balcony 405 having one track 415 and one or more movable and/or portable panels 410 412 414. In embodiments, as illustrated in FIG. 4A, a first movable or portable panel 410 may be positioned adjacent a second movable or portable panel 412 and a second movable or portable panel 412 may be positioned adjacent a third movable or portable panel 414. In embodiments, this provides maximum protection from harmful solar rays because there is no spacing between the movable and/or portable panels 410 412 414. In embodiments, such a configuration as illustrated in FIG. 4A may generate a maximum wind power and/or solar power if wind is directed at the panels (e.g., at a perpendicular direction) and/or if a light source (e.g., sun) is shining directly on the one or more movable and/or portable panels.

FIG. 4B illustrates a balcony having a power and shading system having more than one tracks according to embodiments. FIG. 4B illustrates a balcony 405 have one or more tracks and/or channels 416 417 418 and corresponding one or more movable or portable panels 420 421 422. In embodiments, such as illustrated in FIG. 4B, one movable or portable panel is located in each of the one or more tracks or channels (e.g., panel 420 located in track 416; panel 421 located in track 417; panel 422 located in track 418). In embodiments, such as illustrated in FIG. 4B, panels may be staggered and/or overlapping when looking at panels from front (e.g., such as panels 422 and 424) in order to provide additional shading coverage provided by the one or more panels. In embodiments, one or more tracks and/or channels 416 417 418 may be a straight path and in other embodiments, one or more tracks and/or channels 416 417 418 may be curved path.

FIG. 4C illustrates a balcony having one curved track or channel 419 (although more than one curved track or channel may be utilized in a balcony shading and power system) according to embodiments. In embodiments, such as illustrated in FIG. 4C, three movable or portable panels 430 432 and 434 may be located and/or positioned in curved track or channel 419. In embodiments, movable or portable panels 430 432 434 may have an oval shape, a concave, a convex, a parabolic or other efficient shapes (e.g., efficient shapes to capture solar and/or wind energy). In embodiments, one or more movable or portable panels 430 432 434 may not be right next to each other and may have spacing in between adjacent portable and movable panels. In embodiments, curved movable or portable panels 430 432 434 may be a better option for utilization in curved balconies. In embodiments, balconies having a curved configuration may be present in structures such as hotels and/or condominiums that have curved faces, surfaces and/or sides.

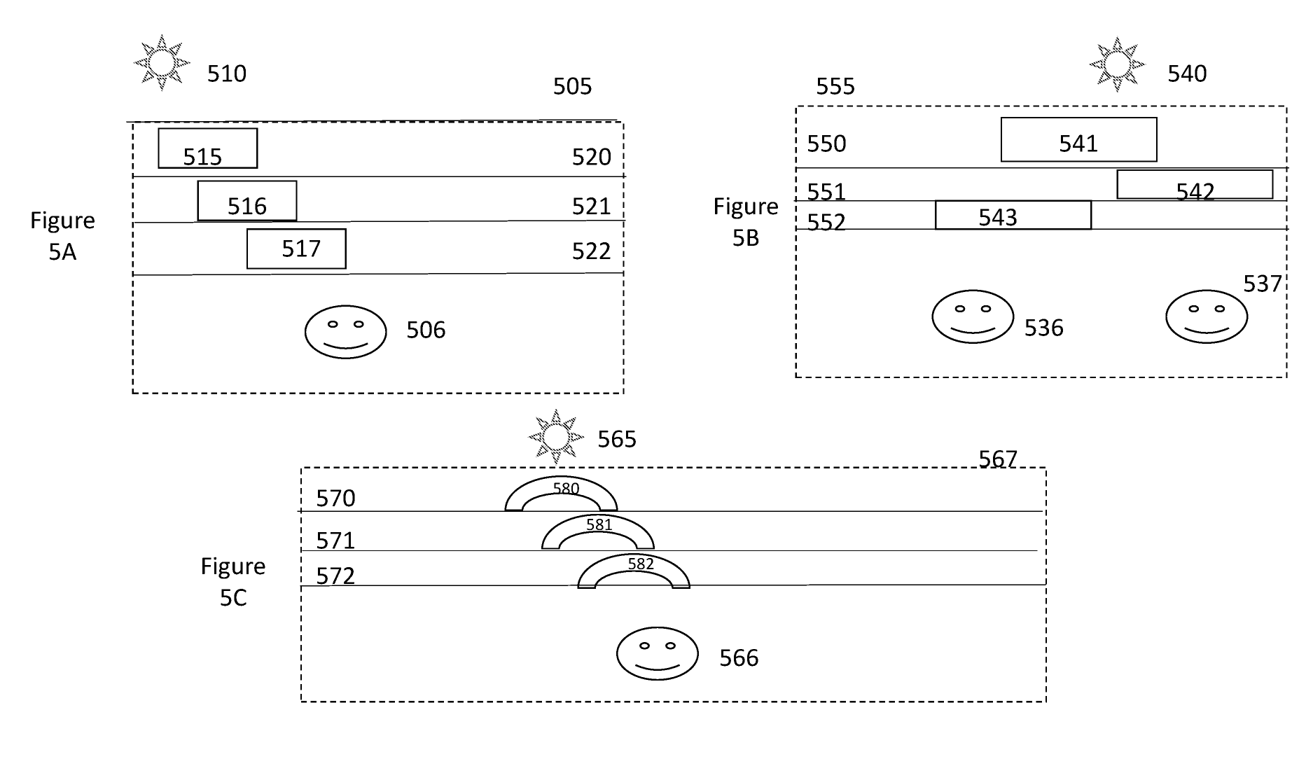

FIGS. 5A, 5B and 5C illustrates different configurations of balcony shading and power systems including different positioning of movable and/or portable panels according to embodiments. FIG. 5A illustrates positioning of a light source, a balcony, tracks and channels of a shading and power system and a user according to embodiments. FIG. 5A illustrates a sun 510, a balcony 505 and a visitor, resident or guest 506. In embodiments, a balcony shading and power system comprises one or more tracks and/or channels 520 521 522 and/or one or more movable or portable panels 515 516 517. In embodiments, a sun 510 may be located on a left side facing a balcony (e.g., position of a sun on a southward facing balcony in a morning) and panels 515 516 517 may be moved towards the right (as illustrated by the arrows) to provide sun protection for visitor, resident or guest who may be located on a balcony 505 or within a room in a position such as illustrated in FIG. 5A. In embodiments, such as illustrated in FIG. 5A, panels 515 516 517 may be staggered and/or offset with respect to each other to provide maximum protection for a visitor, resident or guest.

FIG. 5B illustrates a second configuration of a sun 540, a balcony 555, a balcony shading and power system, and/or two visitors and guests 536 537. In embodiments, a balcony shading and power system comprises one or more tracks and/or channels 550 551 and 552 and one or more movable or portable panels 541 542 and 543. In embodiments, a sun 540 may be located on a right side facing a balcony (e.g., position of sun on a southward facing balcony in early evening) and panels 541 542 and 543 may be moved to the left (or to the right depending on last placement) to provide sun protection for visitors, residents and/or guests, who may be located on a balcony 505. In embodiments, such as illustrated in FIG. 5B, two guests may be on a balcony and movable panels may be moved to provide sun protection for both of the guests. In embodiments of balcony shading and power systems, such as illustrated in FIG. 5B, a portion of panel 541 and panel 542 may be utilized to provide sun protection for visitor or guest 537, whereas a portion of panel 541 and panel 543 may be utilized to provide sun protection for visitor or guest 536. In embodiments, such as illustrated in FIG. 5B, panels 541 542 543 may be moved independently of each other to provide protection for more than one visitors or guests located in different areas of a balcony 555.

FIG. 5C illustrates a third configuration of a sun 565, a balcony 567, a balcony shading and power system and a visitor or guest 566. In embodiments, a balcony shading and power systems comprises one or more tracks and/or channels 570 571 572 and one or more curved movable or portable panels 580 581 and 582. In embodiments, a visitor or guest 566 may be positioned in a center of a balcony 567 and a sun 565 may be positioned slightly to a left of center of a balcony 567. In embodiments, one or more curved movable or portable panels 580 581 582 may be moved to the right (from a rest position) to positions illustrated in FIG. 5C. In embodiments, one or more portable panels 580 581 582 may be overlapping with respect to each other and provide additional sun shade protection for a visitor and/or guest.

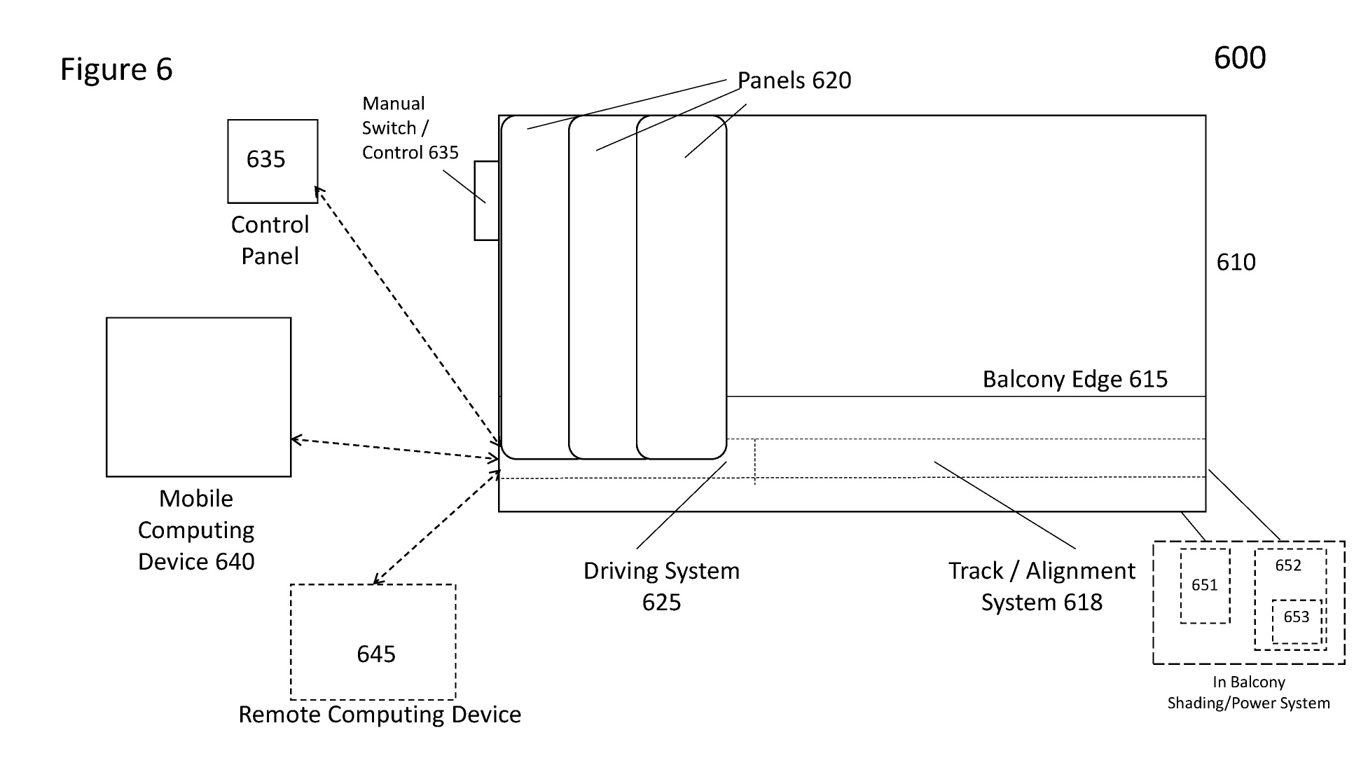

FIG. 6 illustrates a view of a balcony shading and power system from a point of view of an inside of a room according to embodiments. In embodiments, a balcony shading and power system 600 may comprise a balcony 610, a balcony edge 615, a track and alignment system 618, one or more movable or portable panels 620, one or more driving systems 625, and one or more manual/switch controls 630. In embodiments, a balcony shading and power system 600 may comprise a control panel 635, a mobile computing device 640 and/or a remote computing device 645. In embodiments, as illustrated in FIG. 3C, a balcony shading and power system 600 may comprise one or more processors 651, one or more memories or memory modules 652 and/or computer-readable instructions 653 executable by the one or more processers 651. In embodiments, computer-readable instructions 653 may be accessible from one or more memory devices 652 and executable by one or more processors 651 to control operation of a balcony shading and power system. In embodiments, an operator may interface with balcony shading and power system 600 via a display or monitor of a balcony shading and power system which initiates operation and execution of the computer-readable instructions by the one or more processors. In embodiments, a balcony shading and power system 600 may be controlled by a manual switch or control 630. In embodiments, a switch or control 630 may be mechanical, electrical and/or electro-mechanical and may cause one or more movable or portable panels 620 to move from left to right and/or vice versa in one or more track or alignment systems 6618. In embodiments, one or more portable panels 620 may be moved by one or more driving systems or assemblies 625. In embodiments, one or more portable panels 620 may be inserted into one or more driving systems or assemblies 625. In embodiments, a balcony edge 615 may prevent a visitor or guest from falling off a balcony.

In embodiments, a control panel 635 may be positioned anywhere within a room that includes a balcony and shading system 600. In embodiments, a control panel 635 may be mounted on a wall of a room or office. In embodiments, an electronic device (e.g., like a television) may present a control panel 635 on a television screen and a remote control may be utilized to interface and communicate with a control panel 635 to operate a balcony shading and power system 600. In embodiments, a control panel 635 may transmit or communicate selected commands, instructions and/or messages to one or more processors 651 in balcony and shading system 600. In embodiments, computer-readable instructions 653 executed by the one or more processors 651 may process and/or analyze the commands, instructions and messages and generate instructions and/or commands which are communicated to one or more motor controllers in the balcony shading and power system 600. In embodiments, as described previously one or more motor controllers may communicate commands and/or signals to the motor to move and/or adjust the one or more movable or portable panels 620. FIG. 3C illustrates operation of a driving assembly that may be utilized in balcony and shading systems according to embodiments.

In embodiments, a mobile computing device 640 may control operation of a balcony shading and power system 600. In embodiments, as is illustrated in FIG. 3C, a balcony shading and power system may comprise one or more transceivers 354. In embodiments, a portable computing device 640 (e.g., a tablet, smart phone, laptop, PDA, wearable computing device) may communicate commands, instructions and/or messages through one or more transceivers 354 (see FIG. 3C) to one or more processors 651 in a balcony shading and power system 600. In embodiments, computer-readable instructions may be stored in one or more memory devices (e.g., an application on a mobile computing device) and may be executable by one or more processors. In embodiments, computer-readable instructions executable by one or more processors may generate and/or communicate commands, instructions and/or messages through a wireless communication transceiver. In embodiments, computer-readable instructions executable by one or more processors 651 of a balcony shading and power system may receive, process and/or analyze the communicated commands, instructions and messages and generate instructions and/or commands which are communicated to one or more motor controllers 355 (see FIG. 3C) in the balcony shading and power system 600. In embodiments, as described previously one or more motor controllers 355 may communicate commands and/or signals to the motor to move and/or adjust the one or more movable or portable panels 620. In embodiments, computer-readable instructions 353 executed by one or more processors 351 may perform voice recognition on spoken commands and may utilize artificial intelligence and/or machine learning to analyze received instructions and/or commands and generate commands, instructions and/or messages that are communicated to the motor controller.

In embodiments, a remote computing device 645 may control operation of a balcony shading and power system 600. In embodiments, as is illustrated by the driving assembly of FIG. 3C, a balcony shading and power system may comprise one or more transceivers 354. In embodiments, remote computing device 640 (e.g., a server, a third party computing device) may communicate commands, instructions and/or messages through one or more transceivers 354 to one or more processors 651 in a balcony shading and power system 600. In embodiments, computer-readable instructions may be stored in one or more memory devices of a remote computing device 640, may be executable by one or more processors in a remote computing device 640 and may generate the communicate commands, instructions and/or messages that are communicated to one or more processors 651 in a balcony shading and power system 600 via transceivers in a remote computing device and transceivers 354 in a balcony shading and power system 600. In embodiments, computer-readable instructions executable by one or more processors in a remote computing device 650 may perform voice recognition on spoken commands and may utilize artificial intelligence and/or machine learning to determine commands, instructions and/or messages that are to be communicate to the balcony shading and power system 600 (and specifically the motor controllers in the balcony shading and power system 600). In embodiments, computer-readable instructions 653 executable by the one or more processors 651 may process and/or analyze the commands, instructions and messages and generate instructions and/or commands which are communicated to one or more motor controllers 355 (see FIG. 3C) in a balcony shading and power system 600. In embodiments, as described previously one or more motor controllers 355 may communicate commands and/or signals to one or more motors to move and/or adjust the one or more movable or portable panels 620.

Memory, in a computing device and/or a balcony shading and power system, interfaces with computer bus, a power bus and/other communication channels, so as to provide information stored in memory to processor during execution of software programs such as an operating system, application programs, device drivers, and software modules that comprise program code or logic, and/or computer-executable process steps, incorporating functionality described herein, e.g., one or more of process flows described herein. CPU first loads and/or accesses computer-executable process or method steps or logic from storage, storage medium/media, removable media drive, and/or other storage device. CPU can then execute the stored process steps in order to execute the loaded computer-executable process steps. Stored data, e.g., data stored by a storage device, can be accessed by CPU during the execution of computer-executable process steps.

Non-volatile storage medium/media is a computer readable storage medium(s) that can be used to store software and data, e.g., an operating system, system programs, device drivers, and one or more application programs, in a computing device or one or more memory devices of a balcony shading and power system processor, controller and/or computing device. Persistent storage medium/media also be used to store device drivers, (such as one or more of a digital camera driver, motor drivers, speaker drivers, scanner driver, or other hardware device drivers), web pages, content files, metadata, playlists, data captured from one or more assemblies or components (e.g., sensors, cameras, motor assemblies, microphones, audio and/or video reproduction systems) and other files. Non-volatile storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, Windows Phone, Google Phone, Amazon Phone, or the like. A computing device, or a processor or controller in a balcony shading and power system controller may include or may execute a variety of possible applications, such as a software applications enabling communication with other devices, such as communicating one or more messages such as via email, short message service (SMS), or multimedia message service (MMS), FTP, or other file sharing programs, including via a network, such as a social network, including, for example, Facebook, Linkedin, Twitter, Flickr, or Google+ and/or Instagram provide only a few possible examples. A computing device or a processor or controller in a balcony shading and power system may also include or execute an application to communicate content, such as, for example, textual content, multimedia content, or the like. A computing device or a processor or controller in a balcony shading and power system may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in a balcony shading and power system and/or mobile computing device may also include imaging software applications for capturing, processing, modifying and transmitting image, video and/or sound files utilizing the optical device (e.g., camera, scanner, optical reader) within a mobile computing device and/or a balcony shading and power system.

Network link typically provides information communication using transmission media through one or more networks to other devices that use or process the information. For example, network link may provide a connection through a network (LAN, WAN, Internet, packet-based or circuit-switched network) to a server, which may be operated by a third party housing and/or hosting service. For example, the server may be the server described in detail above. The server hosts a process that provides services in response to information received over the network, for example, like application, database or storage services. It is contemplated that the components of system can be deployed in various configurations within other computer systems, e.g., host and server.

For the purposes of this disclosure a computer readable medium stores computer data, which data can include computer program code that is executable by a computer, in machine-readable form. By way of example, and not limitation, a computer-readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, DRAM, DDRAM, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

1. A balcony shading and power system, comprising:
one or more track assemblies;
one or more movable panel assemblies positioned within at least one of the one or more track assemblies, the one or more movable panel assemblies comprising:
one or more solar cells to convert light energy to electrical power; and
one or more wind power assemblies to capture wind and to generate electrical power from the captured wind; and
one or more driving assemblies to move the one or more panel assemblies.

2. The balcony shading and power system of claim 1, wherein the one or more movable panel assemblies provide shade to visitors in a building room that is associated with the balcony.

3. The balcony shading and power system of claim 1, wherein the one or more solar cells are attached to an outside surface of at least one of the one or more movable panel assemblies.

4. The balcony shading and power system of claim 1, wherein the one or more wind power assemblies are integrated into at least one of the one or more movable panel assemblies.

5. The balcony shading and power system of claim 1, wherein a balcony has a curved shape, the one or more track assemblies have a curved shape and the one or more movable panel assemblies have a curved shape.

6. The balcony shading and power system of claim 1, wherein the one or more track assemblies comprises one track assembly, the one or more movable panel assemblies comprises two or more movable panel assemblies and the two or more movable panel assemblies are positioned within the one track assembly.

7. The balcony shading and power system of claim 1, further comprising one or more processors, one or more memory devices and computer-readable instructions stored in the one or more memory devices, the computer-readable instructions executable by the one or more processors to generate movement instructions or commands and to communicate the generated movement instructions or commands to the driving assembly to move the one or more movable panel assemblies.

8. The balcony shading and power system of claim 7, further comprising one or more wireless transceivers, the one or more wireless transceivers to receive messages or commands associated with movement of the one or more movable panel assemblies from an external device.

9. The balcony shading and power system of claim 8, wherein the external device is a mobile computing device.

10. The balcony shading and power system of claim 8, wherein the external computing device is a control panel.

11. The balcony shading and power system of claim 8, wherein the external computing device is a switching assembly or actuator.

12. The balcony shading and power system of claim 1, further comprising a solar charge controller, the solar charge controller to manage power generation of the one or more solar cells.

13. The balcony shading and power system of claim 12, further comprising a rechargeable power source, the rechargeable power source coupled to the solar charge controller, the solar charge controller to transfer generated power to the rechargeable power source.

14. The balcony shading and power system of claim 12, further comprising a power supply, the power supply to power components of the balcony shading and power system, the solar charge controller to transfer generated power, for the solar cells, to the power supply.

15. The balcony shading and power system of claim 1, wherein the one or more wind power assemblies comprises one or more blades, one or more caps, one or more shafts, one or more gearing assemblies and/or one or more power generators.

16. The balcony shading and power system of claim 15, wherein the wind to cause the one or more blades to rotate and the rotation of the blades and the one or more caps causes the one or more shafts to rotate in proportion to a wind speed of the captured wind.

17. The balcony shading and power system of claim 16, wherein the one or more shafts is mechanically coupled to one or more gearing assemblies and the one or more gearing assemblies is coupled to the one or more power generators, wherein rotation of the one or more shafts to cause rotation of the one or more gearing assemblies and the rotation of the one or more gearing assemblies to cause one or more power generators to generate electrical power.

18. The balcony shading and power system of claim 17, further comprising a rechargeable power source, the one or more power generators to transfer the electrical power to the rechargeable power source.

19. The balcony shading and power system of claim 17, further comprising a building structure power supply, the one or more power generators to transfer power to the building structure power supply.

20. The balcony shading and power system of claim 15, the wind power system further comprising a screen, the screen being positioned between a surface of the one or more movable panels and the one or more blades, the screen to protect the one or more blades from objects entering into the wind power system from an environment surrounding the balcony shading and power system.
